(19) United States
(12) Patent Application Publication
(10) Pub. No.: US 2002/0023898 A1
(43) Pub. Date: Feb. 28, 2002

(54) Apparatus for and method of brazing strobe inserts to circular saw blades

(75) Inventors: Eugene L. Brewer JR., Stockton, CA (US); Salvatore R. Trinchera, Stockton, CA (US); James P. Turner, Linden, CA (US)

Correspondence Address: Louis A. Mok, KOPPEL & JACOBS, Suite 107, 555 St. Charles Drive, Thousand Oaks, CA, 91360, US

(73) Assignee: CALIFORNIA CEDAR PRODUCTS COMPANY

(21) Appl. No.: 09/929,573

(22) Filed: Aug. 13, 2001

Related U.S. Application Data
(60) Provisional application No. 60/227,097, filed on Aug. 22, 2000.

(51) Int. Cl. B23K 1/00

(52) U.S. Cl. 219/77; 219/85.14; 219/85.19; 219/85.15

(57) ABSTRACT

A method of brazing a strob insert to the trailing edge of a slot in a strob circular saw blade, the strob insert having first and second, opposed, substantially parallel surfaces, the first surface of the strob insert to be brazed to the edge, comprises the steps of placing the strob insert on an electrode with the second surface of the strob insert in contact with the electrode in heat transfer relationship therewith; applying brazing paste to the first surface of the insert; positioning the electrode so that the first surface of the insert is in a brazing position relative to the edge; and passing an electrical current through the electrode to resistively heat the electrode to a temperature sufficient to cause brazing of the first surface of the strob insert to the edge. Also disclosed is an apparatus for resistance brazing a strob insert to an edge of a generally radially extending slot in a strob-type circular saw blade, the apparatus comprising a mount for supporting the circular saw blade, the saw blade having a central rotational axis; a braze head including a brazing electrode adapted to support and heat a strob insert, the braze electrode being mounted for movement relative to the saw blade slot edge to place the insert in a brazing position relative to the edge; and a switch controlled electrical power supply having an output connected to the brazing electrode for resistance heating the electrode and the strob insert supporting thereby.

### CROSS REFERENCE TO RELATED APPLICATION

This application claims the benefit of U.S. Provisional Application No. 60/227,097 filed Aug. 22, 2000.

### BACKGROUND OF THE INVENTION

1. Field of the Invention

This invention relates generally to circular saw blades of the kind having hardened cutting elements known as strob inserts attached to the trailing edges of slots extending generally radially from the central opening or eye of the saw blade. More particularly, the present invention relates to an apparatus for, and a method of, accurately positioning such strob inserts relative to the circular saw blade and brazing the inserts to the saw blade under controlled temperature.

2. Description of the Related Art

U.S. Pat. Nos. 3,563,286; 3,700,016; 4,123,958; and 4,418,589 are examples of prior art disclosing strob circular saw blades including two or more slots each having a generally radially extending trailing edge to which is attached a “strob insert”, that is, a hardened element having cutting edges extending beyond the planar surfaces of the circular saw plate. Such strob saw blades have several advantages, most notably the ability to saw or trim green or uncured wood. The strob inserts enable the circular saw blade to rip cut through such wood which would otherwise expand against the saw blade and cause it to jam. Strob inserts may be made of any suitable hard metal such as tungsten carbide, cobalt-steel alloy, Stellite® or Studite®, and are available in various lengths, widths, thicknesses and cutting edge angles.

Presently, strob inserts are attached to circular saw blades principally by torch brazing or induction brazing, the latter being by far the most common. Induction brazing utilizes a high frequency current passed through a coil surrounding the strob insert to generate the necessary heat by induction.

Existing techniques for attaching strob inserts are often incapable of providing for accurate positioning of the strob insert relative to the saw slot edge to which the insert is to be attached. Moreover, existing techniques not only fail to heat the strob insert uniformly along its length but also expose the saw blades to temperature levels adversely affecting saw blade tension and blade performance. As a result, strob saw blades are often simply discarded after the strob inserts wear beyond a certain value.

U.S. Pat. Nos. 2,823,295 and 4,110,591 relate to apparatus and methods for brazing tungsten carbide tips on individual circular saw teeth. Both of these patents recognize that the process of brazing carbide tips on circular saw teeth by electrical resistance welding or brazing can cause excessive heating of the teeth causing impairment of their temper and/or tension. The '295 patent addresses this problem by providing a contact arm which engages a saw tooth during the resistance brazing operation so as to bypass a portion of the electrical current and absorb some of the heat so that the tooth is not overheated. In the '591 patent, a carbide tip to be attached to an edge of a circular saw tooth is first separately heated by clamping it between two opposed carbon electrodes forming part of an electrical resistance circuit. After the clamped tip is heated red hot, the electrical circuit is opened and a small amount of brazing paste is applied to the hot tip. Next, the arbor mounted circular saw is rotated until the edge of the tooth engages the clamped, hot tip and brazing paste is applied between the tip and the tooth edge. Last, re-energization of the electrical resistance circuit again causes the tip to become red hot and brazed to the saw tooth edge. The initial heating of the tip before it is brought into engagement with the saw tooth reduces the time that is needed to braze the tip and in this fashion the temperature of the tooth is maintained below a critical value. Neither of these patents addresses the problem of positioning a strob insert relative to a strob-receiving edge of a circular saw blade, let alone the problem of controlling the temperature of the strob insert-receiving portions of a circular saw blade during the strob brazing operation to minimize the adverse effects of excessive temperatures on blade tension.

Accordingly, there continues to be a need for a way to position the strob inserts relative to the saw blade not only accurately but also consistently where multiple inserts are required to be attached to a saw blade, and to braze the strob inserts to a saw blade without exposing the blade to excessive temperatures which can compromise saw blade tension values and saw performance. It is manifest that the ability to reuse strob circular saw blades means considerable cost savings to the user.

### SUMMARY OF THE INVENTION

In accordance with a preferred embodiment of the invention, there is provided a method of brazing a strob insert to the trailing edge of a slot in a strob circular saw blade, the strob insert having first and second, opposed, substantially parallel surfaces, the first surface of the strob insert to be brazed to the edge, the method comprising the steps of placing the strob insert on an electrode with the second surface of the strob insert in contact with the electrode in heat transfer relationship therewith; applying brazing paste to the first surface of the insert; positioning the electrode so that the first surface of the insert is in a brazing position relative to the edge; and passing an electrical current through the electrode to resistively heat the electrode to a temperature sufficient to cause brazing of the first surface of the strob insert to the edge.

In accordance with another aspect of the invention, there is provided an apparatus for resistance brazing a strob insert to an edge of a generally radially extending slot in a strob-type circular saw blade, the apparatus comprising a mount for supporting the circular saw blade, the saw blade having a central rotational axis; a braze head including a brazing electrode adapted to support and heat a strob insert, the braze electrode being mounted for movement relative to the saw blade slot edge to place the insert in a brazing position relative to the edge; and a switch controlled electrical power supply having an output connected to the brazing electrode for resistance heating the electrode and the strob insert supporting thereby.

Although the present invention is described in connection with the attachment of strob inserts, it will be evident to those skilled in the art that, with minor modifications, the same technique may be used to remove worn strob inserts from a strob saw blade by melting and breaking the braze bond with minimum adverse temperature influences on the saw blade. Thus, the invention permits the reconditioning and reuse of strob saw blades that would otherwise be discarded.

### BRIEF DESCRIPTION OF THE DRAWINGS

The above and further objects, advantages and features of the invention will become evident from the detailed description of the invention, below, when read in conjunction with the accompanying drawings in which:

FIG. 1 is a front elevation view of an example of a strob circular saw blade to which strob inserts may be attached using the teachings of the present invention;

FIG. 2 is a front elevation view of a machine incorporating an apparatus in accordance with a preferred embodiment of the invention for brazing strob inserts to strob circular saw blades;

FIG. 3 is a side elevation view of an apparatus in accordance with the present invention for attaching strob inserts to circular saw blades;

FIG. 4 is a perspective view of a brazing electrode in accordance with one aspect of the preferred embodiment of the invention, the brazing electrode being shown in juxtaposition with a portion of a circular saw blade;

FIGS. 5a-5c are top plan, side elevation and front elevation views, respectively, of the brazing electrode shown in FIG. 4;

FIG. 6 is a simplified, block diagram of a system for controlling an apparatus in accordance with the present invention; and

FIGS. 7a-7j are side elevation views of a brazing electrode in accordance with the present invention shown in relationship to a strob circular saw blade and showing the major steps for brazing a strob insert to the trailing edge of a generally radially oriented slot in the saw blade.

### DETAILED DESCRIPTION OF THE INVENTION

The term “brazing” used herein is intended to be accorded its ordinary meaning, namely, a process for producing joints by the flow of a molten filler metal (typically a silver alloy solder) by capillary attraction; the process is also sometimes referred to in the art as silver soldering.

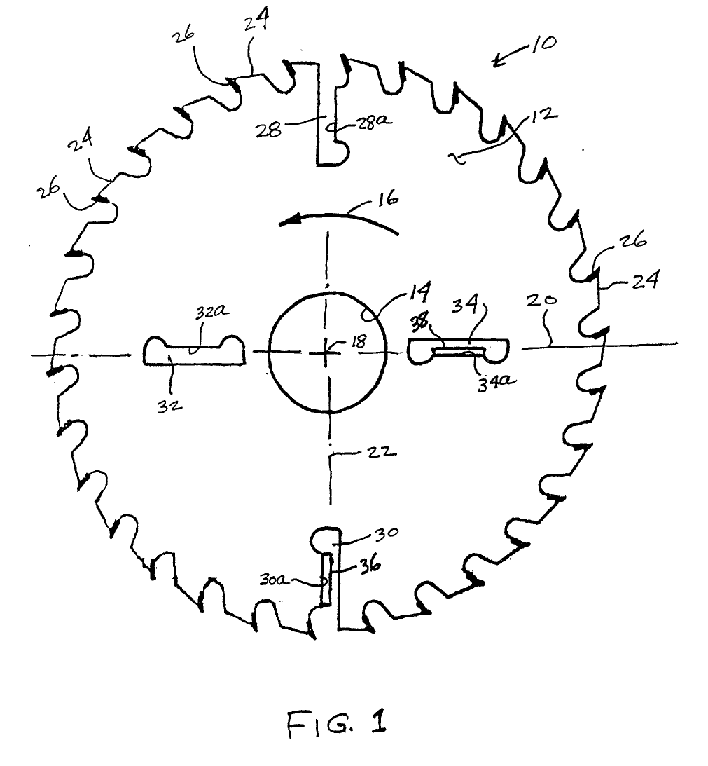

With reference to FIG. 1, there is shown an example of a strob circular saw blade 10 including a plate 12 having a central opening or eye 14. The saw is rotatable in the direction shown by the arrow 16 about a central axis 18 of rotation which, to facilitate the description of the invention will be referred to as the y-axis. For convenience, the saw blade is also referenced to a horizontal x-axis 20 and a vertical z-axis 22, thereby defining mutually perpendicular x, y and z reference axes.

The saw blade 10 includes a plurality of teeth 24 circumferentially positioned around the periphery of the plate. Each tooth has a leading edge relative to the direction of rotation of the blade with each of the edges faced with a tungsten carbide tip 26.

The specific saw blade example shown in FIG. 1 includes a pair of diametrically opposed outer slots 28, 30 each including a trailing edge 28a, 30a relative to the direction of rotation. Each trailing edge extends generally radially of the central axis. As is known in the art, the number configuration and orientation of such slots may vary according to the particular saw blade design and it is not intended to limit the present description to any particular strob circular saw blade design. The strob saw blade further includes a pair of inner slots 32, 34 lying generally on a diameter perpendicular to that of the outer slots. Each of the inner slots includes a generally radially extending trailing edge 32a, 34a for receiving a strob insert. The outer slot 30 and the inner slot 34 are shown with strob inserts 36, 38, respectively, already attached to their trailing edges. The trailing edges of the remaining outer and inner slots 28 and 32 have yet to receive strob inserts.

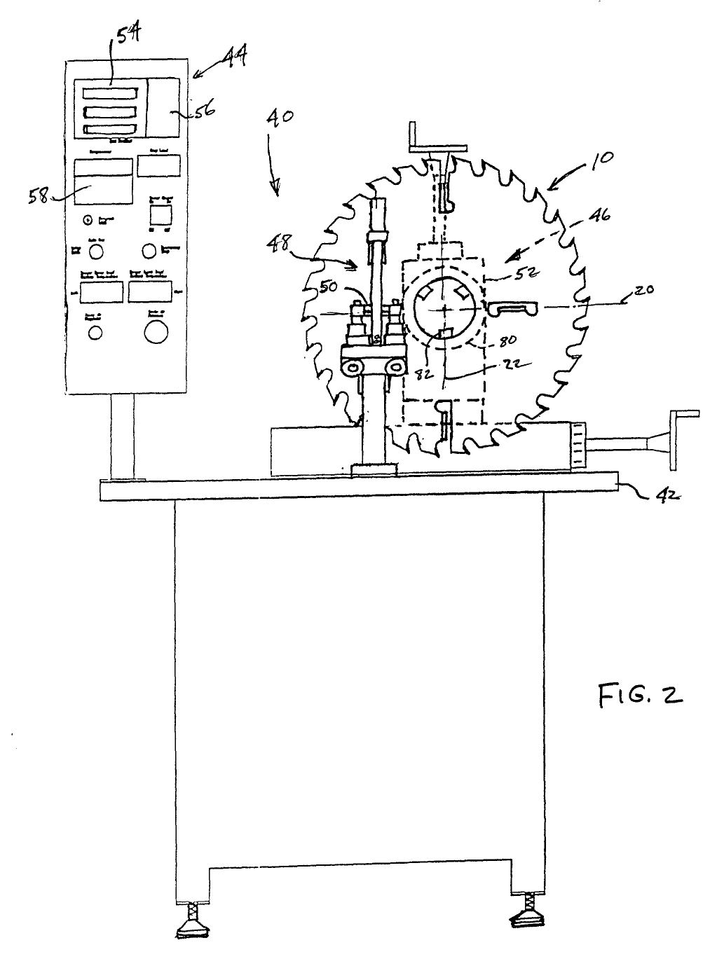

FIG. 2 is a front elevation view of a strob insert attaching apparatus 40 in accordance with the present invention. The apparatus generally includes a table 42 upon which are mounted a control and display panel 44, a mount 46 for carrying and positioning the circular saw blade 10 to which strob inserts are to be attached to edges 32a and 28a, and a braze head 48 carrying a strob insert brazing electrode 50. The saw mount includes a stage 52 for positioning the saw blade along the three mutually perpendicular y-axis 18, x-axis 20 and z-axis 22. The control and display panel 44 includes digital readouts 54 for displaying, among other data, (1) the position of the saw blade along the x, y and z axes; (2) the temperature of the braze head; and (3) the electrical current, in amperes, passing through the braze head. The control and display panel also includes appropriate keypads 56, 58 for entering temperature, cycle time and other data.

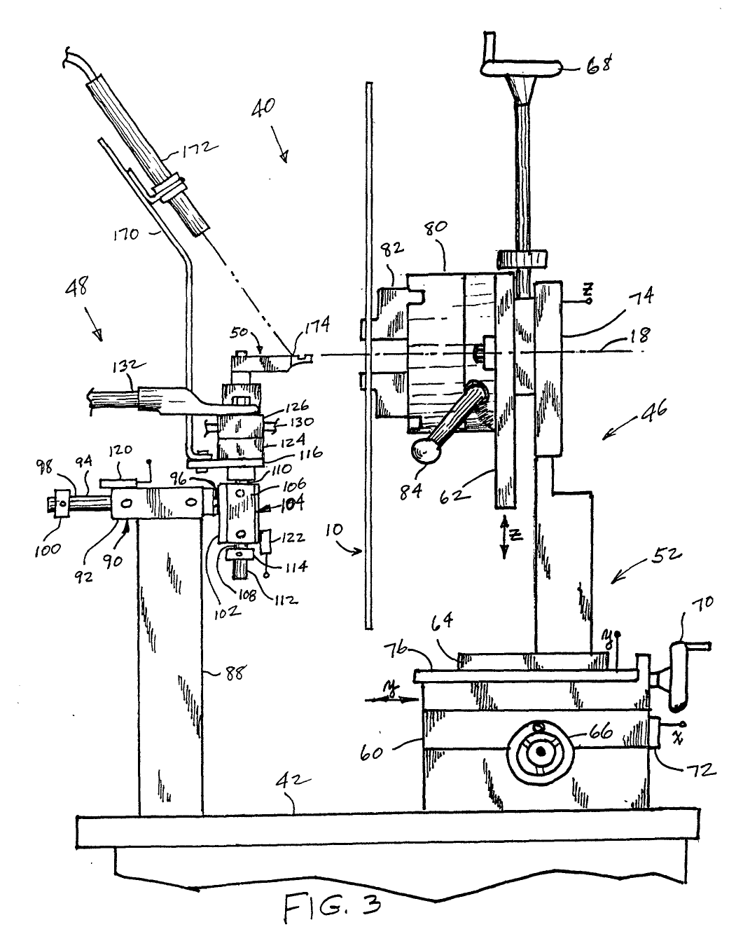

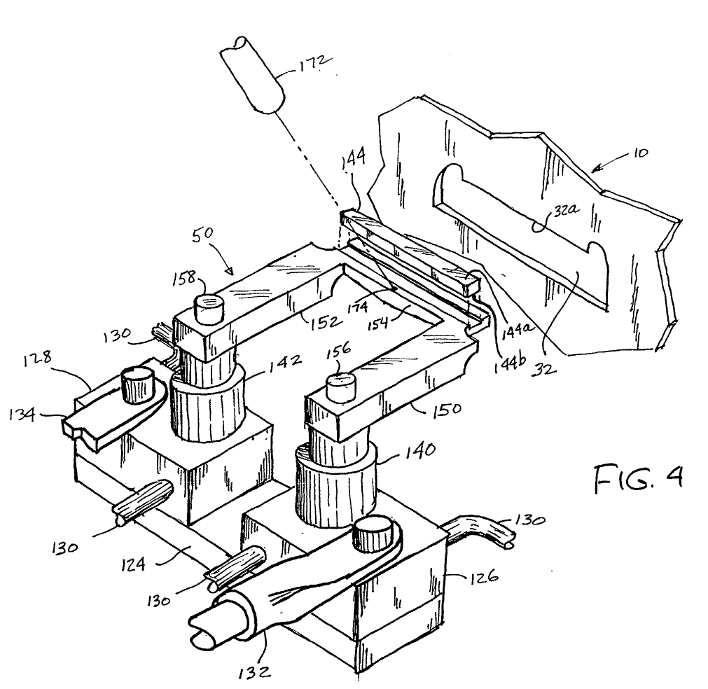

With reference now also to FIG. 3, the x-y-z stage 52 is secured to the table 42 for manually positioning the saw blade 10 bidirectionally along each of the x, y and z directions. The stage includes x linear slide 60, z linear slide 62 and y linear slide 64 manually actuated by means of rotatable handles 66, 68 and 70. The slides include linear position transducers 72, 74 and 76 providing electrical outputs indicative, respectively, of the x, z and y positions of the slides. These outputs are stored in computer memory and their values are displayed on the digital readout 54.

Mounted on the z axis slide 62 is an indexing head 80 including an expanding type mandrel 82 for engaging the edge of the central opening 14 of the saw and supporting the saw in a vertical plane. The indexing head 80 includes a handle 84 movable between locked and unlocked positions permitting the saw to be rotated about the y axis and locked in place at a desired angle or position. Accordingly, the x, y and z stage and indexing head provide four degrees of freedom to position the insert-receiving edge of one of the slots such as the edge 32a of the slot 32, to be brought to an insert brazing position.

The braze head 48 includes a pedestal 88 secured to the table 42. Mounted on the pedestal is a horizontal, linear pneumatic power cylinder 90 having an actuator body 92 carrying a piston rod 94 movable bidirectionally in the y-direction, that is, in a forward direction in which the rod 94 is advanced toward the saw blade mount 46 and in a rearward direction in which the rod is retracted relative to the mount 46. The linear actuator rod 94 has projecting ends 96 and 98 extending forwardly and rearwardly, respectively, from the actuator body 92. The rear end 98 of the rod 94 carries a stop collar 100 adjustably positionable along the rod end 98. The stop collar 100 engages the actuator body 92 in the forwardmost position of the rod 94 thereby limiting forward motion of the rod.

Secured to the forward end 96 of the rod 94 is a block 102 which in the rearmost position of the rod 94 engages the actuator body 92 thereby limiting rearward movement of the rod. The block 102 carries a vertical, linear pneumatic power cylinder 104 having an actuator body 106 carrying a piston rod 108 movable bidirectionally along the vertical or z direction. The actuator displaces the rod 108 vertically between an uppermost position and a lowermost position. The rod includes ends 110 and 112 projecting upwardly and downwardly, respectively, from the actuator body 106. The downwardly projecting end 112 of the rod 108 carries a stop collar 114 adjustably positionable along the rod end 112 for engaging the actuator body 106. Once locked in place on the rod 108, the stop collar 114 limits upward movement of the rod. Secured to the upper end 110 of the rod 108 is a horizontal plate 116 which, in the lowermost position of the rod, engages the actuator body 106 to limit downward movement of the rod.

No Proximity sensors 120 and 122, in the form of reed switches, optical switches, or the like, cooperate with the stop collars 100 and 114 to provide output signals indicating that the rods 94 and 108 are in their forwardmost and uppermost positions.

Referring now also to FIG. 4, mounted on the plate 116 is a thick insulator pad 124 in turn carrying a pair of electrical terminal blocks 126, 128 typically of copper spaced apart along the x direction. To prevent overheating, the terminal blocks 126, 128 are hollow, coolant being circulated through the blocks by means of flexible conduits 130 leading to and from a coolant reservoir and pump unit (not shown). Bolted to the terminal blocks 126, 128 are electrical cable 130, 132 having, respectively, a gauge sufficient to carry the current (for example, 200 amps at 20 volts) required to effect resistance brazing of the strob inserts.

Secured to each terminal block 126, 128 is an upstanding electrically conductive terminal post 140, 142, respectively. Bolted to the upper ends of the posts is the electrically conductive brazing electrode 50 for supporting and heating a strob insert 144.

The brazing electrode 50 is a generally U-shaped, monolithic element including identical, spaced apart parallel legs 150, 152 extending in the y direction, and an elongated platform or cross arm 154 extending in the x direction and connecting the forward ends 150a, 152a of the legs 150, 152.

The legs have rear extremities 150b, 152b with holes receiving bolts 156, 158 for securing the brazing electrode to the tops of the terminal posts 140, 142. Thus, it will be understood that electrical power applied through the cables 132, 134 to the terminal blocks will cause current to flow through the legs and cross arm of the brazing electrode 50 thereby heating the electrode, and particularly the cross arm 154 thereof.

Each of the legs 150, 152 of the brazing electrode has a square cross section. The lower surfaces of the forward ends of the legs have recesses or notches 150c, 152c so that the thickness of the cross arm in vertical dimension is substantially less than that of the legs. Thus, the cross sectional area of the cross arm 154 is substantially less than the cross sectional area of either of the legs. The cross arm has an upper horizontal surface 154a provided with a strob insert-receiving groove 154b of preferably rectangular cross section extending the entire length of the cross arm; a portion of the horizontal surface 154a is disposed rearwardly of the groove. The cross arm has vertical planar ends 154c.

The electrical resistance to the flow of current offered by the brazing electrode 50 as measured across the terminal bolts 156, 158 is such as to cause resistance heating of the brazing electrode and particularly the cross arm whose cross sectional area is substantially less than that of the legs. The cross arm is configured so that when heated by application of electrical power the temperature of the cross arm is substantially constant along its entire length, for example, within ±1° F. Such temperature uniformity may be achieved in various ways. For example, the lower surface 154d of the cross arm may be profiled, for example, tapered symmetrically so that the central part of the cross arm is somewhat thicker than the ends although satisfactory results may also be achieved with a brazing electrode having a cross arm of uniform cross section.

The brazing electrode 50 is cast of a carbongraphite matrix and is covered with, for example, a coating of silicon carbide to retard oxidation. The cold resistance of the brazing electrode as measured across the terminal bolts may be about 41×10⁻⁵ ohms.

The strob insert 144 to be brazed to the edge 32a of the saw slot 32 is placed in the groove 154b along the cross arm of the brazing electrode. The correct position of the strob insert along the length of the groove may be established by lining up one or both end surfaces of the insert with one or both of the ends 154c of the cross arm.

A typical strob insert such as the insert 144 includes a top surface 144a for receiving the brazing or silver solder paste, and a bottom surface 144b which rests on the cross arm in heat transfer relationship therewith.

It will be seen that the pneumatic power cylinders 90 and 104 carried by the pedestal 88 provide the brazing electrode with two degrees of movement, in the y direction toward and away from the plane of the saw, and in the z direction, up and down vertically.

When the brazing electrode is in its forwardmost and uppermost position as established by the stop collars 100 and 114, the upper surface 144a of a strob insert is in the final brazing position which defines a reference position for the saw blade edge 32a to which the insert 144 is to be attached.

Mounted on the braze head plate 116 is a bracket 170 carrying an infrared sensor 172 having a lens system focused on a spot 174 centered on the portion of the upper surface 154a of the cross arm rearward of the insert receiving groove 154b. The sensor 172 provides an output indicative of the temperature of the cross arm and thus the temperature of the strob insert 144 carried by the cross arm. The sensor output is applied to a feedback system for controlling the electrical power applied to the brazing electrode. The control system brings the cross arm to a user selected temperature and holds it at that temperature for a selected period of time.

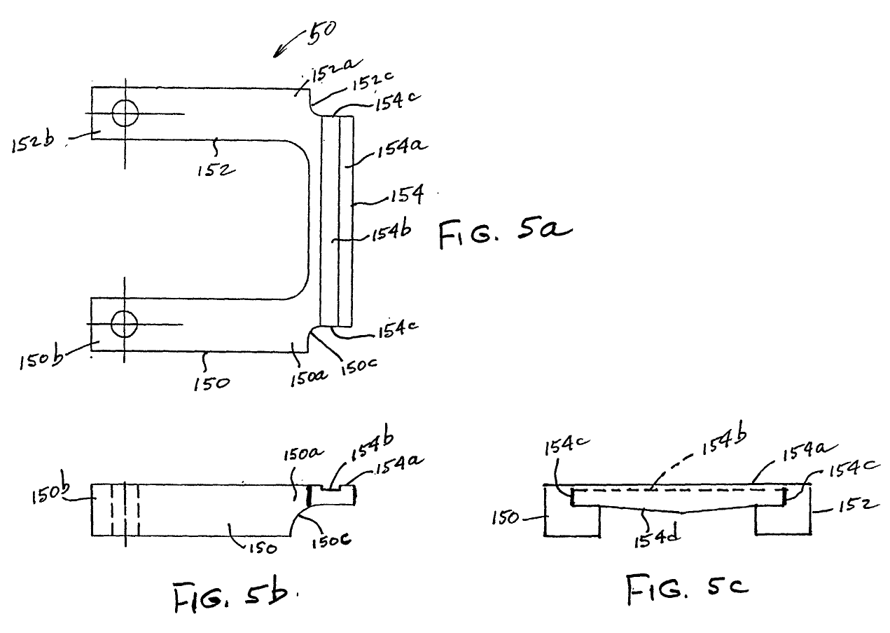

FIG. 6 shows a simplified block diagram of a control system 180 for use in connection with the present invention. Feedback and control circuitry on a microprocessor/controller board 182 receives the temperature dependent signal from the IR detector 172 positioned to sense IR radiation emitted from the braze electrode cross arm. A control signal 184 output from the board 182 controls the current to the braze electrode 50 via a power supply 186 energized by a foot pedal switch 188 and the cables 132, 134. The current so supplied thus resistance heats the braze electrode 50 in response to temperature command signals from the control/display panel 44 and the IR detector output. Outputs applied to the controller circuitry from the proximity sensors 120, 122 on the braze head indicate when the braze electrode is (1) at its forwardmost position and (2) at its braze position to initiate preset heating and cooling intervals. Actuation of the power cylinders 90 and 104 is also controlled by signals from the controller. Last, x, y and z saw position signals are input to the controller for display on the x, y and z digital readouts on the panel 44. Control systems of the type illustrated in FIG. 6, their implementation and programming are all well known in the machine control art.

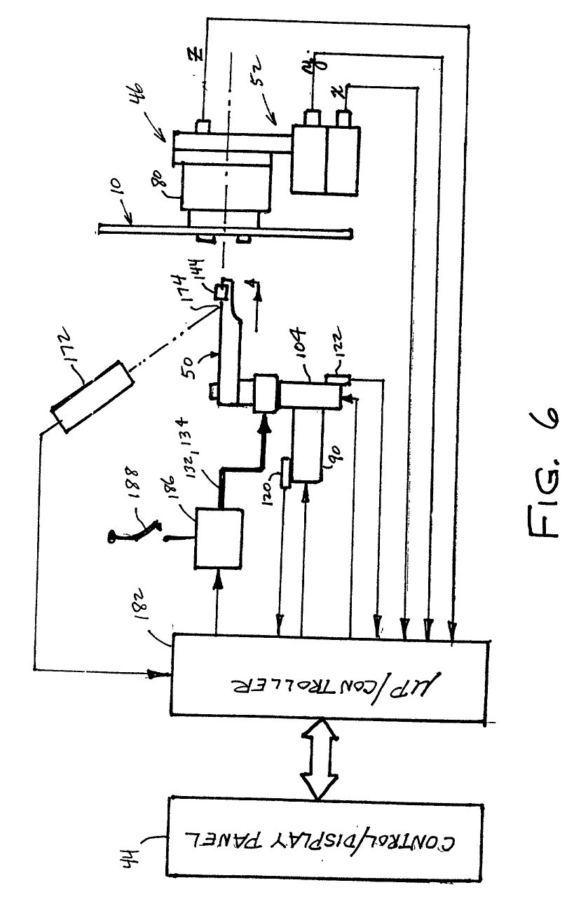

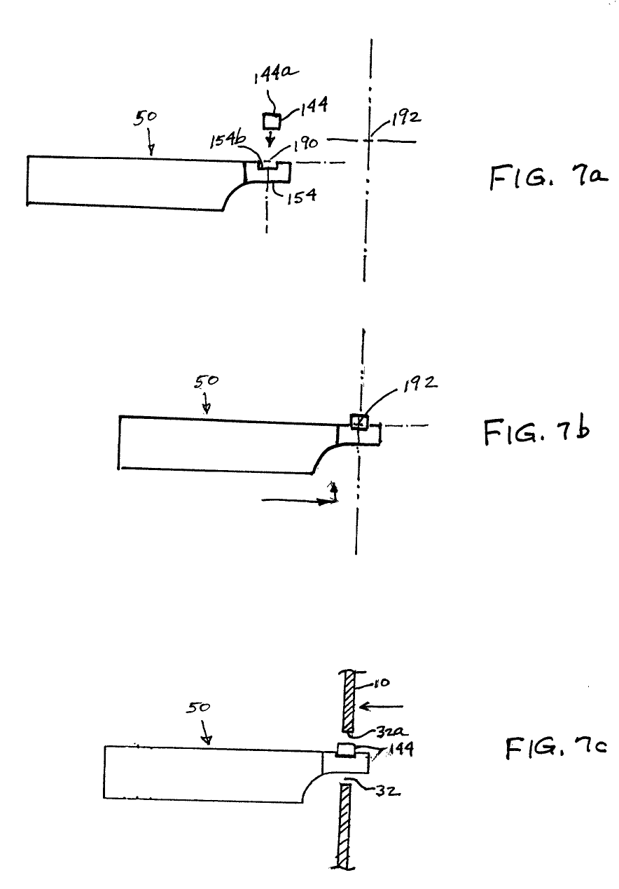

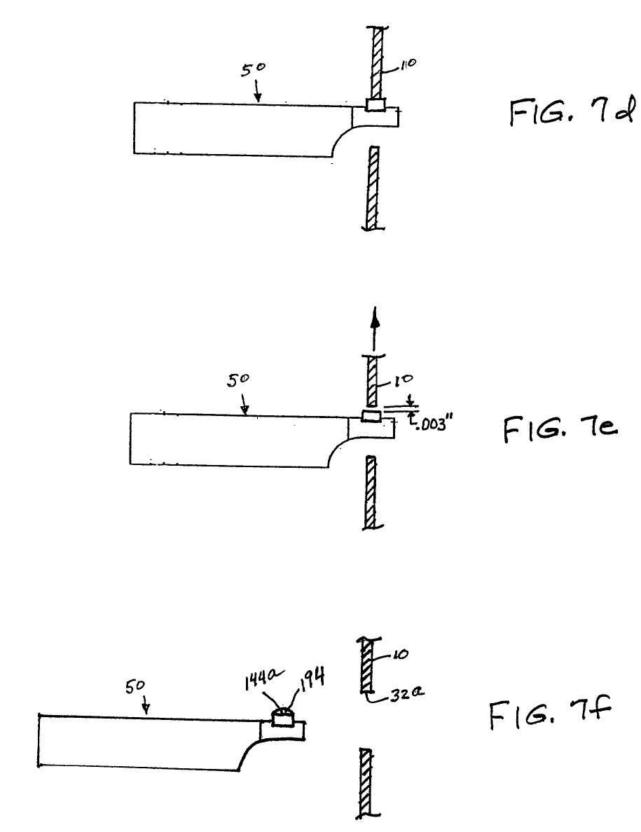

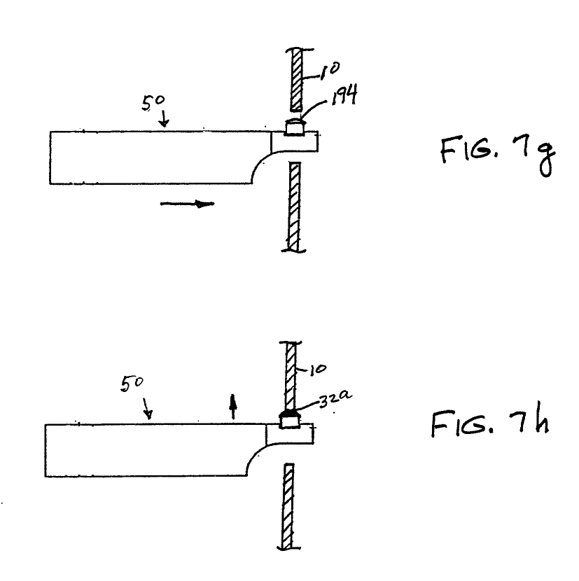

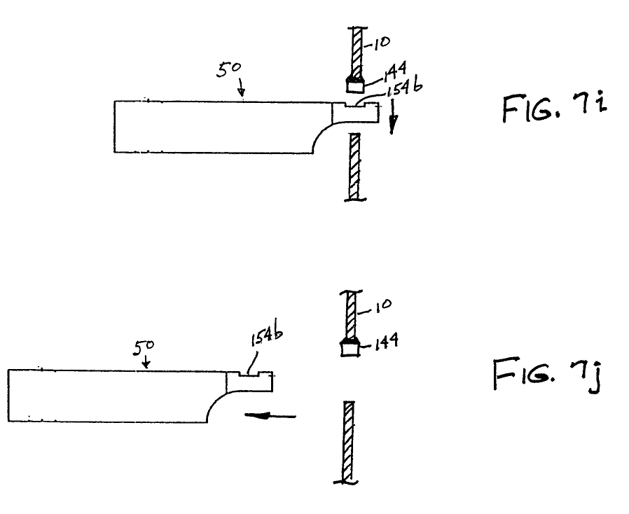

With reference also to FIGS. 7a-7j, in operation, with the electrode 50 in the home position 190, that is, in the retracted, lowermost position, the operator places a strob insert 144 in the groove 154b of the cross arm 154. (FIG. 7a.) On the control and display panel, a setup mode switch is placed in the setup mode. At this point the saw blade 10 has not been mounted on the saw blade mount 46. When the setup mode switch is moved to the setup mode position, the braze head power cylinders 90, 104 are activated to move the brazing electrode 50 to the brazing position 192, that is, to the extremes of its horizontal and vertical movements as established by the stop collars 100, 114. (FIG. 7b.) With the saw blade mount 46 positioned rearwardly along the y axis direction so as not to interfere with the brazing electrode, a circular saw blade 10 is mounted on the expanding mandrel of the indexing head 80. The indexing head is lightly tightened so that a subsequent angular adjustment can be made. Using the manual adjustment handles of the slides 60, 62 and 64, the saw blade is moved so that the brazing electrode enters the slot 32. (FIG. 7c.) The indexing head is rotated clockwise or counterclockwise so that the operator can visually match the angle of the edge 32a to which the strob insert is to be attached with the upper surface 144a of the strob insert. When properly angularly aligned, the indexing head 80 is tightened. Using the manual adjustment handles of the x, y and z stage, the saw blade is moved as necessary to bring the edge 32a into contact with the upper surface 144a of the strob insert. (FIG. 7d.) Vertical and horizontal adjustments may be made to properly position the edge relative to the strob insert in the x and z directions. Similarly, the edge is centered in the y direction relative to the strob insert by adjusting the y-axis slide adjustment handle 70. Once this centering operation is complete, the z-axis adjustment handle 68 is rotated to raise the edge approximately 0.003 inch above the upper strob insert surface. (FIG. 7e.) The size of this gap is typically recommended by the silver solder paste manufacturer so as to accommodate differential expansions of the parts being joined during the heating thereof.

On the control and display panel the x, y and z digital readouts are zeroed. This provides positioning targets for the attachment of subsequent strob inserts to the saw blade and expedites those subsequent setup adjustments.

The setup mode switch is now positioned to the “auto run” position which moves the brazing electrode back to its home position. (FIG. 7f.) Target brazing temperature, electrical current and cycle times are now entered through a keypad on the control panel. Using a solder paste applicator, a stream of silver solder paste 194 is applied to the strob insert upper surface 144a. (FIG. 7f.) Flux is also applied to the saw in a well known manner to prevent bluing of the saw blade and to provide an oxygen free brazing atmosphere. Upon pressing the foot switch 188, the brazing head moves horizontally to the forwardmost end of its horizontal stroke. (FIG. 7G.) The brazing head pauses at the end of this stroke for about two seconds during which resistance heating of the brazing electrode begins. Following this time interval, the brazing head is moved vertically upward to the brazing position while resistance heating of the brazing electrode continues. (FIG. 7h.) The operator visually monitors the brazing operation and when solder flow is discerned, the foot pedal is released.

The brazing head pauses at the brazing position for a short interval to allow cooling and solder solidification. This interval should be long enough for the solder to harden but not long enough for any flux that has run down into the groove 154b under the insert 144 to solidify. During cooling, the solder will harden before the flux hardens. At the end of this cooling interval, the brazing electrode is returned to its home position by first moving down (FIG. 7i.) and then rearwardly along the y-axis direction. (FIG. 7j.)

The saw blade is then rotated to the next strob insert position and the process is repeated, with the positioning of the saw blade being expedited by the previous positioning steps and zeroing of the digital readouts.

Although the present invention has been described in connection with the attachment of strob inserts, it will be evident to those skilled in the art that, with minor modifications, the same technique may be used to remove worn strob inserts from a strob saw blade by melting and breaking the braze bond with minimum adverse temperature influences on the saw blade. For example, instead of leaving a small gap between the cross arm of the brazing electrode and the lower surface of the insert to be removed, the cross arm is brought into engagement with the lower surface of the insert and maintained in such engagement during the heating interval. Thus, the invention permits the reconditioning and reuse of strob saw blades that would otherwise be discarded.

We claim:

1. A method of brazing a strob insert to the trailing edge of a slot in a strob circular saw blade, the strob insert having first and second, opposed, substantially parallel surfaces, said first surface of said strob insert to be brazed to said edge, the method comprising the steps of:
placing said strob insert on an electrode with said second surface of said strob insert in contact with said electrode in heat transfer relationship therewith;
applying brazing paste to said first surface of said insert;
positioning said electrode so that said first surface of said insert is in a brazing position relative to said edge; and
passing an electrical current through said electrode to resistively heat said electrode to a temperature sufficient to cause brazing of said first surface of said strob insert to said edge.

2. The method defined in claim 1 in which:
said strob insert is placed on said electrode with said second surface of said strob insert in contact with said electrode along substantially the entire length of said second surface.

3. The method as defined in claim 1 further comprising the steps of:
measuring the temperature of the electrode; and
controlling the electrical current passed through said electrode in response to said measured temperature to control the temperature of said electrode.

4. The method as defined in claim 3 in which the controlling step further comprises:
controlling said electrical current passed through said electrode in response to a predetermined temperature-time profile.

5. A method of brazing a plurality of strob inserts to the trailing edges of a corresponding number of generally radially extending slots in a strob circular saw blade, each of the plurality of strob inserts having a surface for brazing to said edge of one of said slots, the method comprising the steps of:
(a) placing a strob insert on an insert-supporting surface of an electrode;
(b) moving said electrode to a strob insert-attaching position;
(c) mounting said circular saw blade on an adjustably positionable saw blade mount;
(d) moving said saw blade to a position at which a first edge is brought to said strob insert attaching position;
(e) recording the position of said saw blade mount;
(f) retracting said electrode from said strob insert-attaching position;
(g) applying a brazing filler material to said surface of said strob insert;
(h) moving said electrode to said strob insert attaching position;
(i) resistance heating said electrode and thereby said strob insert and said edge to a temperature sufficient to effect brazing of said insert to said edge;
(j) allowing the strob insert to cool;
(k) retracting said electrode from said strob insert attaching position; and
(l) repeating the foregoing to effect brazing to said saw blade of subsequent ones of said plurality of strob inserts utilizing the recorded position of the saw blade mount to aid in positioning the trailing edges.

6. The method, as defined in claim 5, including the steps of:
measuring the temperature of the strob insert support; and
controlling the temperature support in response to the measured temperature to limit said temperature to values below that adversely affecting the tension of the saw blade.

7. An apparatus for resistance brazing a strob insert to an edge of a generally radially extending slot in a strob-type circular saw blade, the apparatus comprising:
a mount for supporting said circular saw blade, said saw blade having a central rotational axis;
a braze head including a brazing electrode adapted to support and heat a strob insert, said braze electrode being mounted for movement relative to said saw blade slot edge to place said insert in a brazing position relative to said edge; and
a switch controlled electrical power supply having an output connected to said brazing electrode for resistance heating said electrode and said strob insert supporting thereby.

8. An apparatus as defined in claim 7 in which:
said circular saw blade mount includes a stage for supporting said saw blade, said stage being adjustable to position said slot edge relative to said brazing position.

9. The apparatus defined in claim 8 in which:
said stage is adjustable to position said slot edge along three mutually perpendicular directions.

10. The apparatus defined in claim 8 in which:
said circular saw blade mount includes an indexing head mounted on said stage for holding said circular saw blade for adjustably positioning said saw blade angularly about said blade axis and thereby the angular position of said edge relative to said brazing position.

11. The apparatus defined in claim 7 in which:
said braze head includes an actuator coupled to said brazing electrode for moving said electrode along a horizontal direction parallel with the central rotational axis of the saw blade.

12. The apparatus defined in claim 11 in which:
said braze head includes a second actuator for moving said electrode along a vertical direction perpendicular to the central axis of the saw blade.

13. The apparatus defined in claim 7 in which:
said brazing electrode includes an arm for carrying said strob insert along substantially the entire length of said insert, said arm being configured to heat said insert substantially uniformly along substantially its entire length.

14. The apparatus defined in claim 13 in which:
said brazing electrode is made of a carbon-graphite matrix.

15. The apparatus defined in claim 13 in which:
said brazing electrode is coated with a material retarding oxidation of said electrode.

16. The apparatus defined in claim 15 in which:
said coating comprises silicone carbide.

17. The apparatus defined in claim 7 further including:
a temperature sensor positioned to sense the temperature of said brazing electrode, the sensor providing an output representative of said temperature; and
a brazing element temperature control system coupled to said temperature sensor and said electrical power supply, said control system being responsive to said temperature sensor output and a temperature command signal for controlling the electrical power applied to said brazing electrode.

18. An electrode for resistance heating and elongated strob insert to be brazed to a strob saw blade, the electrode comprising:
an elongated strob insert platform having a surface for supporting said strob insert along substantially the entire length thereof, said platform having opposed ends configured for connection to an electrical power supply.

19. The electrode defined in claim 18 in which:
said platform has a groove for receiving said strob insert.

20. The electrode defined in claim 19 in which:
said platform is made of a material comprising a carbon-graphite matrix.

21. The electrode defined in claim 20 in which:
said platform is coated with silicon carbide.

22. An electrode for resistance heating and elongated strob insert to be brazed to a strob circular saw blade, the electrode comprising:
a pair of spaced apart parallel, identical legs, each leg having a first end and a second end;
a cross arm connecting said first ends of said legs, said second ends being configured for connection across an electrical power supply, said cross arm having a length and an upper surface including an elongated groove extending the length of said cross arm for receiving a strob insert, the cross arm being configured to resistively heat said strob insert substantially uniformly along the entire length of said insert.

23. The electrode defined in claim 22 in which:
said cross arm includes a central portion having a cross-sectional area greater than that of the ends of the cross arm.

24. The electrode defined in claim 23 in which:
the electrode is made of material comprising a carbon-graphite matrix.

25. The electrode defined in claim 24 in which:
the outer surface of said electrode is coated with a material retarding oxidation of said electrode.

26. The electrode defined in claim 24 in which:
said coating comprises silicone carbide.

27. The electrode defined in claim 25 in which:
the electrode has a cold resistance of about 41×10⁻⁵ ohms.
